(19) United States
(12) Patent Application Publication
(10) Pub. No.: US 2020/0320875 A1
(43) Pub. Date: Oct. 8, 2020

(54) Coordinated Traffic Feature and Map Generation for Convoy Operations

(71) Applicant: Alberto Daniel Lacaze, (US)

(72) Inventors: Alberto Daniel Lacaze, Potomac, MD (US); Karl Nicholas Murphy, Rockville, MD (US)

(73) Assignee: Alberto Daniel Lacaze, Gaithersburg, MD (US)

(21) Appl. No.: 16/377,340

(22) Filed: Apr. 8, 2019

(51) Int. Cl. G08G 1/09; G05D 1/00; G05D 1/02; H04L 29/08

(52) U.S. Cl. CPC G08G 1/091; G05D 1/0088; G05D 1/0293; G05D 1/0295; G05D 2201/0213; G05D 1/0246; G05D 1/0231; G05D 1/0214; H04L 67/12; G05D 1/0255

(57) ABSTRACT

A system comprising sensors such as a camera, LADAR, ranging sensors, or acoustic sensors that can detect road features in which the lead autonomous vehicle and other autonomous vehicles in the convoy senses a variety of information like traffic signals, traffic signs, whether the road is muddy, lane changes, convoy pullover, traffic circles, etc. ahead of time and transmits the information to the convoy of autonomous vehicles coming behind via a communication mechanism from the database of the lead autonomous vehicle or other autonomous vehicles to the database of the rest of the autonomous vehicles. There is a communication mechanism between the database of the lead autonomous vehicle and the other autonomous vehicles coming behind or there can be a communication mechanism between any of the autonomous vehicles and the other autonomous vehicles coming behind. There is also a localization system between the lead autonomous vehicle and other autonomous vehicles.

### CROSS-REFERENCE TO RELATED APPLICATIONS

U.S. Pat. No. 16/105,801

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

### 1. Field of the Invention

The present invention relates to a navigation system comprising a set of sensors that can detect features such as a camera, or LADAR, or ranging sensor, or acoustic sensor for autonomous vehicles in a road network in which the lead autonomous vehicle as well as other autonomous vehicles in the convoy sees all the information ahead such as stop signs, turn signals, lane changes, convoy pullovers, traffic circles, intersections, and road conditions and transmits the information to the convoy of autonomous vehicles that are coming behind it.

### 2. Description of Related Art

The statements in this section merely provide background information related to the present disclosure and may not constitute prior art.

There is a great need for autonomous vehicles to be able to communicate with each other as part of a navigation system in which information is conveyed to other autonomous vehicles about the appropriate action to take next during travel. This is necessary so that the convoy of autonomous vehicles continue the path that is intended by the lead autonomous vehicle or another autonomous vehicle. Currently, there are no reports in the literature of any such communication system being established directly between autonomous vehicles.

There has been a navigation system developed for guiding unmanned vehicles with any desired wheel configuration without guide wire for free movement on paths and along curves. The system is discussed in U.S. Pat. No. 5,219,036. Another navigation system with distance limitation mechanism has been described in US. Pat. No. 2012/0089328. Both patents do not involve a lead truck conveying information to other trucks in the convey.

Another patent, U.S. Pat. No. 8,346,480 discusses a navigation and control system which has sensors to locate objects in a predetermined field of view. The navigation and control system include a processor configured to determine the existence and location of the objects in the three-dimensional field of view based on a position of a vehicle.

There is one patent in which there is a system that transmits data from the aircraft of the convoy and ground control and one control device, at least partly automatic for at least one following aircraft of the convoy. In this case the data from the convoy of aircraft is transmitted to the ground control and control device and this is different from the case of having a lead vehicle transmitting road information to the rest of the convey.

There is also a patent related to a vehicle with a satellite navigation receiver that transmits signals on geographic positions to the base station and can store many of the signals and is described in U.S. Pat. No. 6,144,196. While this invention relates to transmitting signals to the base station, it does not convey a wide variety of different kinds of information and also does not convey them to an entire convoy which comprises multiple trucks.

There are no patents that involve a lead autonomous truck sending navigation information directly to other autonomous vehicles in the convoy.

### SUMMARY OF THE INVENTION

The present invention describes a navigation system comprising a set of sensors that can detect features such as a camera, LADAR, ranging sensors, or acoustic sensors. A lead autonomous vehicle or other autonomous vehicles detects and generates road information on a wide variety of road conditions such as stop signs, turn signals, turn signs, intersections, traffic circles, convoy pullovers, lane changes, and road before the rest of the trucks and transmits the information to the rest of the convoy via a communication mechanism between the databases of the lead or other autonomous vehicles and the rest of the autonomous vehicles that come behind it. FIG. 1 illustrates a wide variety of common signs that are found in roads that must be detected by autonomous trucks.

There is a road network and a communication mechanism between the database of the lead autonomous vehicle and the following autonomous vehicles. In addition, there is a localization system on both the lead autonomous vehicle and the following autonomous vehicles.

The lead autonomous truck or other autonomous truck needs to stop sufficiently far out so that the convoy has time to stop or conduct the appropriate action depending on the traffic signal, traffic sign, lane change, or other road conditions.

### BRIEF DESCRIPTION OF THE DRAWINGS

FIG. 1 shows a plurality of traffic road signs commonly used in the United States, as must be recognized by the lead autonomous truck or other autonomous trucks in the present invention.

FIG. 2 shows a schematic of the sensor suite present in the lead autonomous vehicle (201) and the autonomous vehicle coming behind (205) which detects traffic features (200) in a road network (204) which are stored in a database (202) in the lead autonomous vehicle. There is a communication mechanism (203) between the database of the lead autonomous vehicle and that of the database of the autonomous vehicle coming behind.

FIG. 3 shows examples of a lead autonomous vehicle (301) sensing a stop sign, a red light, a red arrow, or a no right turn sign (300) in the road network (302) sufficiently ahead of time to allow the rest of the convoy to correspondingly stop after receiving the information via the communication mechanism from the database of the lead autonomous vehicle and the rest of the autonomous vehicles.

FIG. 4 shows an example of another autonomous vehicle (400) sensing the stop sign, a red light, a red arrow, or a no right turn sign (401) in the road network (402) sufficiently ahead of time and the rest of the convoy correspondingly stop after receiving the information via the communication mechanism from the database of the other autonomous vehicle and the rest of the autonomous vehicles.

### DETAILED DESCRIPTION OF THE INVENTION

The present invention involves having a lead autonomous vehicle that senses road features and generates a lot of road information and conditions and passes that information along to the convoy of autonomous vehicles that follow behind it.

Elements in the Figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

Unless specifically set forth herein, the terms “a,” “an,” and “the” are not limited to one element, but instead should be read as meaning “at least one.” The terminology includes the words noted above, derivatives thereof, and words of similar import.

The particulars shown herein are given as examples and are for the purposes of illustrative discussion of the embodiments of the present invention only and are presented in the cause of providing what is believed to be the most useful and readily understood description of the principles and conceptual aspects of the present invention.

For the lead autonomous vehicles and the other autonomous vehicles, the detection of other vehicles, pedestrians, and obstacles is one of the most important tasks. The distance from these other items when a detection is first made is an indication of the overall health of the sensing side of the autonomous system. In addition, the lead autonomous truck or other autonomous truck must transmit this information to the other autonomous vehicles to follow the instructions that are provided.

Additionally, the lead autonomous vehicle and other autonomous vehicles needs to predict the future location of the moving objects in its surroundings. Typically, the prediction is probabilistic, for example, a 75% chance that an autonomous vehicle may continue straight or a 25% chance that it will turn right. The lead autonomous vehicle or other autonomous vehicle needs to detect this motion and pass the information on to the other autonomous vehicles so that they can take the appropriate action. The presented invention can record the predictions at each time-step for later analysis. During post processing the track that the other vehicle eventually follows would be known and compared with each prediction. The comparison of the prediction with the subsequent motion of the other autonomous truck provides a measure of the accuracy of the prediction and, therefore, an assessment of the safety of the vehicle.

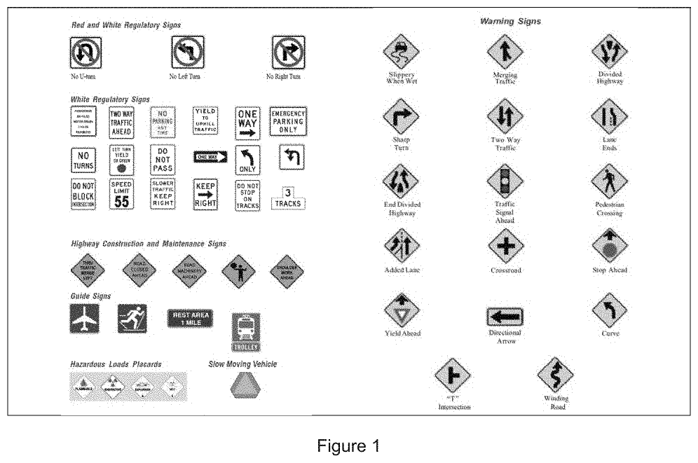

The invention further comprises a database with the rules of the road pertinent to a locale. In general, there are 40 to 60 rules that govern safe operation in each locality. Other rules are still necessary and but may not be explicit. For example, if the lead autonomous vehicle or other autonomous vehicle takes 10 seconds to detect and start moving when a light turns green, it is important that there are internal rules in place involving timing and distance on when the rest of the autonomous convoy correspondingly goes forward in the green light. The same type of internal rules applies for all types of traffic signals such as red light, yellow light, flashing red light, flashing yellow light, red turn signals, yellow turn signals, and green turn signals. These rules also apply for all the signs shown in FIG. 1 and is not limited to these signs.

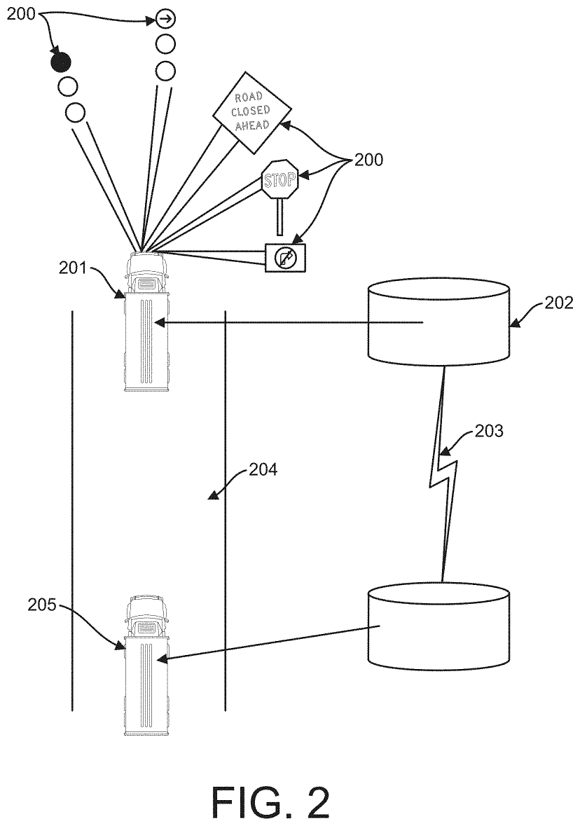

FIG. 2 shows a schematic of how the sensor suite works for the detection of features on a road network. The sensor can be a LADAR, a ranging sensor, or an acoustic sensor. There is a sensor suite present in both the lead autonomous vehicle and the autonomous vehicle following it. The sensor detects features present in the road network and stores it in a database of the lead autonomous vehicle. Then, the information is transmitted to the database of the autonomous vehicle coming behind via a communication mechanism. There is also a localization system in both autonomous vehicles.

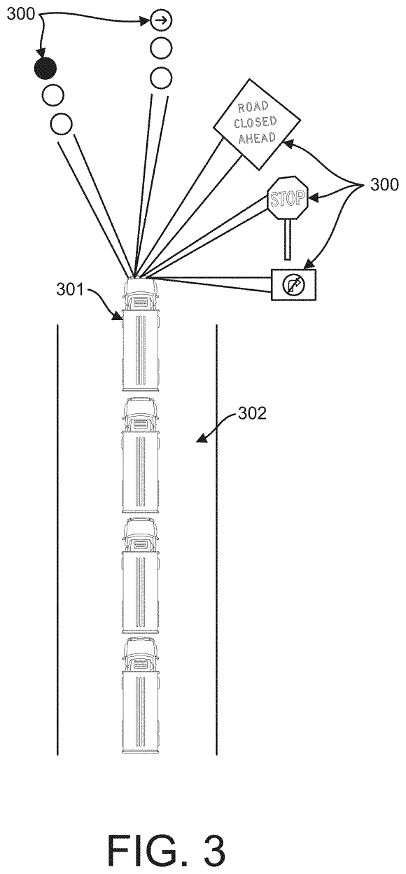

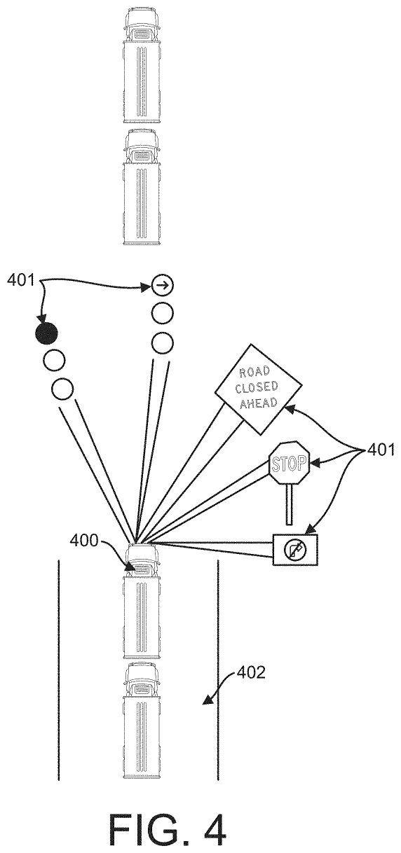

When there is a stop sign present in the road network, the lead autonomous vehicle or other autonomous vehicles sense the stop sign and transmits the information about the database of features from the lead autonomous vehicle to the database of features in the rest of the autonomous convoy via the communication mechanism at a sufficient distance out that there is a stop sign ahead and instructing them to stop at the sign. These scenarios are illustrated in FIGS. 3 and 4. A sufficient distance in this case is one that allows enough time for the lead autonomous vehicle or other autonomous vehicle to stop and give enough time for the rest of the autonomous vehicles to correspondingly stop at the stop sign.

When there is a solid red light present in the road network, the lead autonomous vehicle detects the presence of the solid red light and transmits the information from the database of features in the lead autonomous vehicle or other autonomous vehicle via the communication mechanism at a sufficient distance out that there is a solid red light ahead and instructing them to stop at the red light. A sufficient distance is one that allows enough time for the lead autonomous vehicle or other autonomous vehicle to stop and give enough time for the rest of the autonomous vehicles to correspondingly stop at the solid red light.

When there is a red arrow present in the road network, the lead autonomous vehicle or other autonomous vehicle senses the presence of the red arrow at a sufficient distance out and passes on the information from the database of features of the lead autonomous vehicle to the database of features in the other autonomous vehicles in the convoy via a communication mechanism. The rest of the autonomous vehicles are instructed to stop at the red arrow light. A sufficient distance is one that allows enough time for the lead autonomous vehicle or other autonomous vehicle to stop and give enough time for the rest of the autonomous vehicles to correspondingly stop at the red arrow.

When there is a flashing red light present in the road network, the lead autonomous vehicle or other autonomous vehicle detects the presence of the flashing red light at a sufficient distance out and conveys the information from the database of features in the lead autonomous vehicle or other autonomous vehicle to the database of features in the rest of the autonomous vehicles coming behind via a communication mechanism. The rest of the convoy is then instructed to stop at the red flashing signal. A sufficient distance in this case is one that allows enough time for the lead autonomous vehicle or other autonomous vehicle to stop and give enough time for the rest of the autonomous vehicles to correspondingly stop at the flashing red light.

When there is a solid yellow light in the road network, the lead autonomous vehicle or other autonomous vehicle senses the presence of the solid yellow light at a sufficient distance out and uses a communication mechanism to transmit the information from the database of features of the lead autonomous vehicle or other autonomous vehicle to the database of features in the rest of the convoy. These vehicles are instructed to stop or proceed cautiously if they cannot safely do so. A sufficient distance when a solid yellow light is present is one that allows enough time for the lead autonomous vehicle or other autonomous vehicle to stop or cautiously proceed ahead if it cannot safely stop and give enough time for the rest of the autonomous vehicles to correspondingly stop or proceed cautiously if they cannot safely do so.

When there is a yellow arrow present, the lead autonomous vehicle or other autonomous vehicle detects the presence of the yellow arrow at a sufficient distance out and uses a communication mechanism to relay information from the database of features in the lead autonomous vehicle to the database of features in the rest of the autonomous convoy. The vehicles in the rest of the convoy are instructed to follow the next traffic signal which includes a solid green light, solid red light, or a red arrow. is providing information to the other autonomous trucks that there is yellow arrow and instructing them to follow the next traffic signal which could be a solid green light, solid red light, or a red arrow. In the case of a yellow arrow, a sufficient distance is one that allows enough time for the lead autonomous vehicle or other autonomous vehicle to follow the next traffic signal which could be a solid green light, solid red light, or a red arrow and give enough time for the rest of the autonomous vehicles to correspondingly follow the next traffic signal. There are three different scenarios that could occur in the case of the autonomous trucks following the next traffic signal. If the next traffic signal is a solid green light, the autonomous trucks should proceed straight ahead or turn left or right based on whether there are any cars in front of them in the opposite side. If the next traffic signal is a solid red light, the autonomous trucks should stop at the signal. If the next traffic signal is a red arrow, the autonomous trucks should stop at the signal.

When there is a flashing yellow light present, the lead autonomous vehicle or other autonomous vehicle senses that there is a flashing yellow light present at a sufficient distance out and transmits the information generated in the database of features of the lead autonomous vehicle or other autonomous vehicle via the communication mechanism. The information is relayed, and the rest of the convoy is instructed to slow down and yield to any pedestrians, bicyclists, and vehicles that are present in the road network. In the case of a flashing yellow light, a sufficient distance is one that allows enough time for the lead autonomous vehicle or other autonomous vehicle to slow down and yield to any pedestrians, bicyclists, and vehicles present in the road network and give enough time for the rest of the autonomous vehicles to follow suit.

When there is a solid green light present, the lead autonomous vehicle or other autonomous vehicle senses that there is a solid green light at a sufficient distance out and relays the information to the rest of the convoy via a communication mechanism between the database of the lead autonomous truck or other autonomous truck and the database of features in the rest of the convoy to proceed ahead. A sufficient distance in the case of a solid green light is one that allows enough time for the lead autonomous vehicle or other autonomous vehicle to proceed ahead and give enough time for the rest of the autonomous vehicles to follow to also proceed ahead. There are three options that convoy of autonomous trucks can follow when a solid green traffic signal is sensed. The entire convoy can proceed straight ahead, it can turn left if there are no cars coming straight ahead on the opposite direction, or it can turn right if there are no cars proceeding toward the right side of the road from the left side.

When there is a green arrow present in the road network, the lead autonomous vehicle or other autonomous vehicle detects that there is a green arrow at a sufficient distance out and relays the information to the rest of the convoy via a communication mechanism between the database of the lead autonomous truck or other autonomous truck and the database of features in the rest of the convoy. A sufficient distance in the case of a green arrow is one that allows enough time for the lead autonomous vehicle or other autonomous vehicle to proceed in the direction of the arrow and give enough time for the rest of the autonomous vehicles to proceed in the direction of the arrow. In this case, the green arrow can be a green left arrow or a green right arrow. In both cases, the autonomous vehicles can turn without having to worry about anyone being in front of them in the opposite side.

When a traffic signal is not working (blackout) in the road network, the lead autonomous vehicle senses that the traffic signal is not working at a sufficient distance out and conveys the information to the rest of the autonomous vehicles via a communication mechanism between the database of the lead autonomous vehicle or other autonomous vehicle that a traffic signal is not working (blackout) and instructing them to proceed cautiously as if there are stop signs in all four directions. A sufficient distance in the case of a traffic signal not working is one that allows enough time for the lead autonomous vehicle or other autonomous vehicle to proceed cautiously as if there are stop signs in all four directions and give enough time for the rest of the autonomous vehicles in the convoy to follow suit.

When there is a yield sign in the road network, the lead autonomous vehicle or other autonomous vehicle detects that there is a yield sign present at a sufficient distance out and uses a communication mechanism to relay information from the database of features of the lead autonomous vehicle or autonomous vehicle to the database of the rest of the convoy and instructs them to slow down and stop if necessary and to let any vehicle, bicyclist, or pedestrian pass before proceeding. A sufficient distance out in the case of the presence of a yield sign is one that allows enough time for the lead autonomous vehicle or other autonomous vehicle to slow down or stop if necessary and to let any vehicle, bicyclist, or pedestrian pass before proceeding and give enough time for the rest of the autonomous vehicles to also follow suit.

When there is a square red and white regulatory sign in the road network, the lead autonomous vehicle or other autonomous vehicle senses that there is a square red and white regulatory sign present at a sufficient distance out in the road network and relays instructions to the other autonomous trucks in the convoy via a communication mechanism between the two different databases of features to follow the instructions indicated on the specific sign. An example of a square red and white regulatory sign is the DO NOT ENTER sign which often will also have WRONG WAY written in addition. In this case, the lead autonomous truck or other autonomous truck should sense the Do Not Enter sign a sufficient distance away and give instructions to the rest of the convoy to turn around when it is safe so that the autonomous vehicles are facing the right direction. A sufficient distance is one that allows enough time for the lead autonomous vehicle or other autonomous vehicle to stop and turn around and give instructions to the rest of the autonomous vehicles to also stop and turn around.

When there is a sign with a red circle with a red line through it, the lead autonomous vehicle or other autonomous vehicle detects that there is a sign with a red circle with a red line through it at a sufficient distance out and instructs the other autonomous vehicles and instructs them to NOT do the action on the sign. A sufficient distance out is one that allows enough time for the lead autonomous vehicle or other autonomous vehicle to NOT take the action on the sign and also to give instructions to the rest of the convoy to correspondingly NOT take the action on the sign. There are a few different examples of signs that have red circles with a red line through it. One example is a no U-turn sign. In this case, the lead autonomous vehicle and other autonomous vehicles will sense the sign a sufficient distance out and instruct the rest of the convoy to proceed straight ahead, turn left, or turn right if there is a green light, to safely stop or cautiously proceed straight, turn left, or turn right if there is a yellow light and to stop if there is a red light. Another example is a no left turn sign. In this case, the lead autonomous vehicle and other autonomous vehicles will sense the sign a sufficient distance out and instruct the rest of the convoy to proceed straight ahead or turn right if there is a green light, to safely stop or cautiously proceed straight or turn right if there is a yellow light, and to stop or turn right if there is a red light. Yet another example of a sign with a red circle with a red line through it is a no right turn sign. In this case, the lead autonomous vehicle and other autonomous vehicles will sense the sign a sufficient distance out and instruct the rest of the convoy to proceed straight ahead or turn left when possible when there is a green light, to safely stop or cautiously proceed straight or proceed left when there is a yellow light, or to safely stop if there is a red light.

When there is a black and yellow circular sign or an x-shaped sign, the lead autonomous vehicle or other autonomous vehicle senses that there is a black and yellow circular sign or an x-shaped sign at a sufficient distance out and instructs the other autonomous vehicles in the convoy to look, listen, slow down, and stop if necessary to let any trains pass. A sufficient distance out is one that gives enough time for the lead autonomous vehicle or other autonomous vehicle to look, listen, slow down, and stop if necessary to let any trains pass as well as to relay the information to the rest of the autonomous convoy to also look, listen, slow down, and stop if necessary to let any trains pass.

When there is a blue and white sign in the case where the autonomous vehicles are stalled in the railroad crossings, the lead autonomous vehicle or other autonomous vehicle senses the blue and white sign at a sufficient distance out and conveys the information to the rest of the autonomous trucks to follow the instructions on the sign. A sufficient distance out is one that allows enough time for the lead autonomous vehicle or other autonomous vehicle to follow the instructions on the blue and white sign as well as relay the instructions to the rest of the convoy to also follow the instructions on the sign.

When there is a 5-sided sign, the lead autonomous vehicle or other autonomous vehicle senses that there is a crosswalk and stops if there are children present at a sufficient distance out and also gives instructions to the rest of the convoy to also stop at the crosswalk if there are children walking there. A sufficient distance out is one in which there is enough time for the lead autonomous vehicle or other autonomous vehicle to stop in the front of the crosswalk if there are children walking and also pass on the information to the rest of the convoy to also stop at the crosswalk if there are children present.

When there is a four-sided diamond-shaped sign, the lead autonomous vehicle and other autonomous vehicle detects that there is a four-sided diamond sign at a sufficient distance out to follow the instructions on the sign and instructs the rest of the autonomous convoy to follow suit. A sufficient distance out is one that gives enough time for the lead autonomous vehicle or other autonomous vehicle to follow the instructions on the sign as well as give instructions to the rest of the convoy to correspondingly follow the instructions on the sign.

There are numerous examples of four-sided diamond shaped signs. Some are highway construction and maintenance signs. One sign is THRU TRAFFIC MERGE LEFT and the lead autonomous truck or other autonomous trucks must detect this sign 100 meters ahead of time and provide the information to the rest of the convoy that they need to change lanes and merge into the left lane. Another sign is ROAD CLOSED AHEAD and in this case the lead autonomous truck or other autonomous trucks must detect this sign at a sufficient distance ahead of time and provide the information to the rest of the convoy that they need to stop and turn around' A third sign is ROAD MACHINERY AHEAD and here, the lead autonomous truck or other autonomous trucks must detect the sign at a sufficient distance ahead of time and provide instructions to the other autonomous trucks to use caution when proceeding ahead due to the dangerous conditions ahead. Another sign is SHOULDER WORK AHEAD and, in this case, the lead autonomous truck or other autonomous trucks must detect the sign at a sufficient distance ahead of time and provide the information to the rest of the convoy that caution should be used when proceeding ahead since work is being done in the shoulder of the road. A sufficient distance out is one that gives enough time for the lead autonomous vehicle or other autonomous vehicle to follow the instructions on the highway construction and maintenance sign as well as give instructions to the rest of the convoy to correspondingly follow the instructions on the sign

Other examples of four-sided diamond shaped signs are hazardous loads placards. Four such placards are the FLAMMABLE, RADIOACTIVE, EXPLOSIVES, and TOXIC signs and the lead autonomous vehicle or other autonomous trucks must detect these signs at a sufficient distance out and convey the information to the rest of the convoy to stop and possibly turn around. A sufficient distance out is one that gives enough time for the lead autonomous vehicle or other autonomous vehicle to follow the instructions on the hazardous loads placards as well as give instructions to the rest of the convoy to correspondingly follow the instructions on the sign

Many warning signs are also for-sided diamond shaped signs and these signs also need to be sensed a sufficient distance out and the information needs to be relayed on to the rest of the convoy by the lead autonomous truck or other autonomous trucks. Warning signs include the following: Slippery When Wet, Merging Traffic, Divided Highway, Sharp Turn, Two Way Traffic, Lane Ends, End Divided Highway, Traffic Signal Ahead, Pedestrian Crossing, Added Lane, Crossroad, Stop Ahead, Yield Ahead, Directional Arrow, Curve, Intersection, and Winding Road. A sufficient distance out is one that gives enough time for the lead autonomous vehicle or other autonomous vehicle to follow the instructions on the warning sign as well as give instructions to the rest of the convoy to correspondingly follow the instructions on the sign

When there is a white regulatory sign, the lead autonomous vehicle or other autonomous vehicle senses the presence of the white regulatory sign at a sufficient distance out and also instructs other autonomous vehicles that there is a white regulatory sign and instructing them to respond appropriately based on the meaning of the sign. A sufficient distance out is one that allows enough time for the lead autonomous vehicle or other autonomous vehicle to follow the instructions in the white regulatory signs and to instruct the rest of the convoy to follow suit.

There are many different white regulatory signs including the following: PEDESTRIAN, BICYCLIST, MOTOR-DRIVEN TRAFFIC PROHIBITED, TWO WAY TRAFFIC AHEAD, NO PARKING ANY TIME, YIELD TO UPHILL TRAFFIC, ONE WAY, EMERGENCY PARKING ONLY, NO TURNS, LEFT TURN YIELD ON GREEN, DO NOT PASS, ONLY, TURN WITH TWO DIFFERENT ARROWS, DO NOT BLOCK INTERSECTION, SPEED LIMIT SIGN, SLOWER TRAFFIC KEEP RIGHT, KEEP RIGHT, DO NOT STOP ON TRACKS, 3 TRACKS. These signs need to be detected at a sufficient distance out by the lead autonomous vehicle or other autonomous vehicle and the information needs to be relayed to the rest of the convoy to also follow these instructions. A sufficient distance out is one that gives enough time for the lead autonomous vehicle or other autonomous vehicle to follow the instructions on the white regulatory signs and to relay the information to the rest of the autonomous vehicles to correspondingly follow the instructions on these signs.

When there is a lane change occurring, the lead autonomous vehicle or other autonomous truck senses a lane change that is occurring at a sufficient distance out to give enough time for the other autonomous vehicles behind it to also make the appropriate lane change. In addition, the lead autonomous vehicle or other autonomous vehicle is relaying information to the other autonomous vehicles in the convoy that there is a lane change coming up and to correspondingly make the appropriate lane change based on these instructions. A sufficient distance out is one that gives enough time for the lead autonomous vehicle or other autonomous vehicle to make the lane change and convey that a lane change is coming up to rest of the convey so they can make the lane change in a timely and orderly manner.

When there is a convoy pullover, the lead autonomous vehicle or other autonomous vehicles senses the convoy pullover at a sufficient distance out to give enough time for the other autonomous vehicles to correspondingly slow down and stop to make the pullover. A sufficient distance out is one that gives enough time for the lead autonomous vehicle or other autonomous vehicle to slow down and stop to make the pullover and also relay instructions to the rest of the convoy that they also need to correspondingly slow down and stop for the pullover in a timely and orderly manner.

When there is a traffic circle present, the lead autonomous vehicle senses the traffic circle at a sufficient distance out for the other autonomous vehicles to follow the lead autonomous vehicle or other autonomous vehicle into the traffic circle. A sufficient distance out is one that gives enough time for the lead autonomous vehicle or other autonomous vehicle to follow the lead autonomous vehicle or other autonomous vehicle in the traffic circle in an orderly manner.

When there are solid yellow lines present in the road network, the lead autonomous vehicle or other autonomous vehicle detects the solid yellow lines at a sufficient distance out in order to proceed straight ahead and not pass to the other side of the road and also conveys the instructions along to the rest of the autonomous vehicles that they need to proceed straight and not pass to the other side of the road. A sufficient distance is one that allows enough time for the lead autonomous vehicle or other autonomous vehicle to proceed straight ahead without passing to the other side of the road and also to relay the information to the rest of the convoy to also correspondingly proceed straight in the road.

When there are broken yellow lines present in the road network, a lead autonomous vehicle or other autonomous vehicle senses the broken yellow lines and allows the vehicle to pass to the other side of the road, overtake a vehicle, and return to the same side of the road. In addition, instructions are conveyed to the rest of the autonomous vehicles that there are broken yellow lines present and that is safe to pass to the other side of the road to overtake a vehicle and return to the original lane. A sufficient distance out is one that allows enough time for the lead autonomous vehicle or other autonomous vehicle to pass to the other side of the road, overtake a vehicle, and return to the same side of the road as well as convey the instructions to the rest of the autonomous vehicles that it is safe to also pass for overtaking a vehicle.

When there are solid white lines present, a lead autonomous vehicle or other autonomous vehicle detects the solid white lines a sufficient distance out and proceeds straight ahead in a one-way street and also instructs the rest of the convoy to also proceed straight ahead and that it is a one-way street. A sufficient distance out is one in which there is enough time for a lead autonomous vehicle or other autonomous vehicle to proceed straight ahead in a one-way street and also pass along the information for the rest of the convoy to follow the same path in the road network.

When there are broken white lines that are present, a lead autonomous truck or other autonomous vehicle detects broken white lines indicating that it is safe to pass and return to the original lane if desired and also to relay this information to the other autonomous trucks so they can pass other vehicles if necessary or wanted. A sufficient distance out is one in which there is enough time for a lead autonomous vehicle or other autonomous vehicle to pass a vehicle and return to the original lane and also to convey this information to the rest of the convoy so they can also correspondingly pass vehicles if needed or wanted.

In addition, there are several kinds of guide signs such as airplane, man walking, rest area, trolley, and slow-moving vehicle that must be detected by the lead autonomous vehicle or other autonomous vehicles. These signs need to be detected at a sufficient distance out by the lead autonomous vehicle or other autonomous vehicle and appropriate actions taken based on the specific sign sensed. A sufficient distance out is one in which there is enough time for the lead autonomous vehicle or other autonomous vehicle to take appropriate action and also instruct the rest of the autonomous convoy that they need to take the appropriate action next based on the specific sign.

On a two-way, two-lane road in the United States, the lead autonomous vehicle and other autonomous vehicles will proceed in the right-hand lane for each direction. There is no need for the autonomous vehicles that are going in opposite directions to signal to one another which lane they will use as the rule of the road defines the behavior. In addition, the lead autonomous vehicle or other autonomous vehicles must pass the information on to the rest of the autonomous convoy that they are travelling in a particular lane in the road. Different countries or different locales may have rules that are opposite such as, in England, under the exact same circumstances, it will be understood that the autonomous vehicles will drive in the left lane. Understanding the rules and the locale to which they apply is not only important, but mandatory for safe interaction between autonomous vehicles. The lead autonomous vehicle or other autonomous vehicle will sense at a sufficient distance out that it needs to travel a particular lane depending on the country or locale and passes instructions to the rest of the convoy that these instructions on the proper lanes to travel should be followed. A sufficient distance out is one allows enough time for the lead autonomous vehicle or other autonomous vehicle to proceed to the proper lane and also to convey the information to the rest of the autonomous vehicles that they need to proceed in the appropriate lane.

The sensing information of the autonomous system used for the lead autonomous truck and other autonomous trucks, the distances, classification qualities, and changes of classification, can be used as a determination of the state of the sensors and the processing. As another example, if another vehicle is first detected at 50 meters, and the applicable rule requires a 55-meter safety distance, the detection is not enough even though the self-driving vehicle may not have broken the rule given its actions. If another vehicle is detected at a sufficient distance out to give enough time for the next vehicle to have an appropriate safety margin, then the detection would be enough. The same is true for misclassifications. If a pedestrian 60 meters away is labeled as “vegetation,” and the classification changes from vegetation to pedestrian as the lead autonomous truck or other autonomous truck approaches, such errors present a clue that the sensors are not performing their task as efficiently as they should with respect to the rules of the road. The classifications sensed by the lead autonomous vehicle or other autonomous vehicle should be the same as the classifications sensed by the rest of the autonomous convoy in order for the sensors to be working properly.

The invention will also determine if the lead autonomous truck or other autonomous trucks are correctly detecting and following traffic control signals. These include, but are not limited to, Solid Red Light, Red Arrow Light, Flashing Red Light, Solid Yellow Light, Yellow Arrow Light, Flashing Yellow Light, Flashing Yellow Arrow Light, Green Light, Green Arrow Light, and Traffic Signal Lights not working. The behavior of the lead autonomous vehicle or other autonomous vehicles under each of these signals needs to be examined and verified for correctness. After the invention determines that the lead autonomous vehicle or other autonomous vehicles are in the lane corresponding to the particular signal, it will have to verify that the signal reported by the lead autonomous vehicle or other autonomous vehicles matches the ground truth. It will also need to verify that the lead autonomous vehicle or other autonomous vehicle and the rest of the convoy follow the appropriate action based on the specific signal that is displayed in the traffic light once it is detected a sufficient distance out to give enough time for the autonomous vehicles to respond appropriately. This verification is performed by the invention, either by sensing the signal with its own cameras and processing the images, or by using ground truth provided by the test course. The invention will then compare if the traffic signal sensed and reported by the lead autonomous vehicle or other autonomous vehicles matches the ground truth. Detection distances and accuracies are compared against ground truth. In addition, the lead autonomous vehicle or other autonomous trucks need to pass on the information to the other lead autonomous vehicle.

After it is determined that the signal was correctly detected and at a reasonable distance to allow the lead autonomous vehicle or autonomous vehicle to drive the speed limit and stop before the switch, then the invention checks if the signal is followed. The invention also checks if the behavior is correct when the lights are malfunctioning or turned off. In this case, the local regulations usually require that the autonomous system assumes that the intersection is a four way stop. Therefore, the lead autonomous truck and other autonomous trucks must follow precedence rules. In addition, the invention checks to see if the signal detected by the lead autonomous vehicle or other autonomous vehicle is followed by the other autonomous vehicles.

The invention also verifies if the autonomous system understands traffic signs. Specifically, the invention checks for stop signs, yield signs, “do not enter” signs, “wrong way” signs, “no U-turn” signs, railroad signs, pedestrian walkway signs, animal crossing signs, and any other commonly used road signs at that locale. The invention is not limited to the signs listed here. Once again, the invention will get ground truth for a test course, and compare the detections provided by the autonomous system against the built-in data to verify that the signals have been detected correctly, and at which distances they have been detected. Once the correct detection has been verified, the invention then verifies that the behavior marked by the sign was followed. For example, if there is a wrong way sign, the autonomous system should not attempt to drive in those lanes. In addition, it will be tested to see if the other autonomous vehicles in the convoy also correspondingly follow the instructions provided by the lead autonomous vehicle or another autonomous vehicle. Most locales will require that autonomous vehicles are safe even if the infrastructure is down, and it is likely that there will be requirements for the autonomous vehicles to follow the signs even if the infrastructure is down. FIG. 1 shows a plurality of traffic road signs that are commonly used in the United States. This invention is not limited to the recognition and information passing of only these signs.

The invention will also check to ensure that an autonomous vehicle complies with right-of-way rules, speed limits, lane control, turn signals, and passing rules. All of these rules must be detected at a sufficient distance out to give enough time for the lead autonomous vehicle to follow the specific rules and also to instruct the rest of the autonomous vehicles to follow these rules.

Crosswalks: The invention verifies that the autonomous system yields to pedestrians in crosswalks. It verifies that the crosswalk is detected at a sufficient distance to stop, that the pedestrian at the crosswalk is detected with enough distance to stop, that the pedestrian has right of way, that the lead autonomous vehicle stops when the pedestrian has the right of way, and that the lead autonomous vehicle or other autonomous vehicles does not stop when the pedestrian does not have the right of way. A sufficient distance out is one in which there is enough time for the crosswalk to and pedestrian in the crosswalk to be detected by the lead autonomous vehicle and other autonomous vehicle as well as the rest of the convoy. It also verifies that there is enough safety buffer that is maintained around the pedestrian, the stopping of the autonomous trucks is not abrupt, the vehicle follows the demarcation lines, and it stops without encroaching into the pedestrian walkway areas. “Sufficient distance” is defined differently depending on the locality but it is generally one that gives enough time for the autonomous vehicles to stop at the crosswalk in the presence of pedestrians walking. In addition, the information and instructions need to be passed on to the rest of the autonomous convoy so that appropriate action can be taken.

Intersections: The invention verifies that the intersection rules are followed. The lead autonomous vehicle or other autonomous vehicle detects that there is an intersection present at a sufficient distance out and follows the appropriate rules for the intersection based on the traffic signals or traffic signs that are present at that intersection. A sufficient distance out is one that gives enough time for the lead autonomous vehicle or other autonomous vehicle to follow the intersection rules and convey the instructions to the rest of the convoy to follow these rules. Even if there is no “STOP” or “YIELD” sign, the lead autonomous vehicle or other autonomous vehicles must detect the signs, or lack thereof, and follow the requirements. In particular, yield and precedence rules are verified both for other vehicles and pedestrians. At a “T” intersection without a stop or yield sign, pedestrians have the right of way. If this is a 4-way intersection, some locales give precedence to crossing pedestrians, while others do not. Some locales give precedence to vehicles coming from the right, while others do not. The invention is aware of the different rules for the different locales and can decide on whether the local ordinances are followed. The invention will also verify that the lead autonomous truck or other autonomous trucks are applying the correct turning signals at the correct distances. Some locales prescribe that the signals must be turned on at a certain distance or time from the intended turn. The lead autonomous truck or other autonomous trucks must pass on the information to the rest of the autonomous convoy of trucks of the signs or lack of signs that are detected and follow the instructions based on the meaning of the signs.

Roundabouts: The invention verifies if the lead autonomous vehicle or other autonomous vehicles slow down before entering a roundabout. Many locales require this slow down even if no signs are posted. The lead autonomous vehicle or other autonomous vehicle detects the presence of a roundabout in the road network and then slows down before entering a roundabout at a sufficient distance to allow enough time for the rest of the convoy to follow these vehicles into the roundabout. The invention verifies that the autonomous system finds all pedestrian walkways with sufficient distance to stop, and that it detects pedestrians in these walkways with sufficient time to stop. Finally, the invention verifies that the lead autonomous vehicle or other autonomous vehicles is in the outer lane before turning, and not in the outer lane if continuing within the circle. In many roundabouts, these rules are changed by using road markings. The invention will verify that these road markings are followed. The invention will also verify that the turning signals are applied at the correct time. Turning signals in a roundabout must comply with local regulations. Some regulations state that the signal needs to be turned on at a certain distance, unless there is another turn in the same direction within that distance. The invention takes the local rules into consideration and verifies that the correct logic is followed. The invention also verifies that the direction of travel is correct, given the local rules. In addition, it is important that all of the consecutive steps required in a roundabout are detected by the lead autonomous vehicle or other autonomous vehicle as well as information and instructions passed onto the rest of the autonomous convoy vehicles to take corresponding action at the roundabout.

Mountain Roads: Many locales have special rules for mountain roads. For example, on a narrow mountain road, a lead autonomous truck or other autonomous truck going downhill must yield to an autonomous truck going uphill. The autonomous truck going downhill must back up until there is enough space to where the vehicle going uphill can pass. The invention will verify that the autonomous system can make the determination of what vehicle is going uphill, and what vehicle is going downhill; that the right of way is obeyed, and that the autonomous system safely backs up to provide right of way to the oncoming car. All of this needs to be detected at a sufficient distance out to give enough time for the lead autonomous vehicle or other autonomous vehicle to follow the rules for mountain roads according to the locality that the road is situated. Similarly, if the autonomous vehicle is going uphill, and therefore has right of way, the lead autonomous vehicle or other autonomous vehicles must sense the presence of this uphill motion and allow time for the downhill vehicle to move out of the way and this has be do done at a sufficient distance out to give enough time for the autonomous vehicles to follow the rules of the mountain roads. The lead autonomous truck or other autonomous truck must also provide instructions to the other autonomous trucks in the convoy of the rules of the road that apply for mountain roads and also provide information and instructions to the rest of the convoy on appropriate actions to take on these types of roads.

Maximum Speed Limit: The invention will verify that the lead autonomous vehicle or other autonomous vehicles do not exceed or go below the speed limit either by going over the maximum or under the minimum speed. This requires that the lead autonomous vehicle or autonomous vehicles detect the maximum speed limit and minimum speed limit posted on the road network and maintain a speed within this range. In addition, the minimum and maximum speed limits must be detected at a sufficient distance out so that the lead autonomous vehicle or autonomous vehicles can follow the speed limit rules. A sufficient distance out means that there is enough time for the autonomous vehicle to appropriately slow down or speed up to be within the speed range allowed. Some localities have signs indicating the maximum speed limits, while others have an inherent speed limit that is assigned by the road type. In addition, the lead autonomous truck or other autonomous trucks must pass on the information about the speed limit rules and provide instructions to the other autonomous trucks in the convoy on whether to maintain the speed limit, reduce the speed limit or increase the speed limit depending on the current speed limit of the autonomous truck and the actual speed limit posted on the road.

Reduced Speeds: Some localities have weather-related rules, for example, maximum speed is 35 mph when fog is present. Condition of the road, work being performed, pedestrians present, school buses, and other factors are also incorporated into the rules. The road conditions, work being conducted, and a wide variety of other factors need to be sensed by the lead autonomous vehicle and the other autonomous vehicle at a sufficient distance out to give enough time for these vehicles to follow the rules of the localities and also to transmit the information to the rest of the convoy of the rules that must be followed. The invention uses these rules to verify if the rules have been met. The lead autonomous truck or other autonomous truck must detect the road conditions and the appropriate speeds for each of these conditions and pass on the information and instructions on appropriate actions for the other autonomous vehicles.

Heavy Traffic or Bad Weather: The invention takes into consideration heavy traffic or bad weather to determine if the speed is appropriate, according to the rules of the locality. The lead autonomous vehicle or other autonomous vehicles must detect that there is heavy traffic or bad weather at a sufficient distance ahead and then determine the appropriate speed for the convoy to proceed in and pass on these instructions to the rest of the convoy. A sufficient distance ahead is one in which there is enough time for the lead autonomous vehicle or other autonomous vehicle to follow the rules established by the locality and also transmit the information to the rest of the autonomous convoy.

Towing Vehicles, Buses, or Large Trucks: The invention takes into consideration if the lead autonomous vehicle or other autonomous vehicle is towing a trailer that may have a different inherent maximum speed. The same is true if the autonomy is installed on a bus or large truck, which may be subject to different regulations. The lead autonomous vehicle or autonomous vehicles must obey a different inherent maximum speed when towing a trailer or bus or large truck. The lead autonomous vehicle or other autonomous vehicle must detect at a sufficient distance out what speed the trailer, bus or large truck is going at so that it correspondingly goes at the appropriate speed. In addition, the autonomous vehicle must transmit the information to the rest of the autonomous convey coming behind. These autonomous vehicles must provide instructions to the rest of the convoy that a different speed is required since the lead autonomous vehicle or other autonomous vehicles is towing a trailer or bus or a large truck. A sufficient distance out is one that gives enough time for the lead or other autonomous vehicle to detect the speed being traversed by the trailer, bus, or truck and transmit the information to the rest of the convoy.

Around Children: Many localities have special rules related to children, child zones, and school buses. The invention verifies that rules related to these special conditions are met. For example, the U.S. state of California stipulates that when driving within 500 and 1000 ft from children, the speed limit is capped at 25 mph. This rule requires that an autonomous system allowed to drive in California must be able to recognize and classify a pedestrian child at 1000 ft, or otherwise always drive at less than 25 mph, or be in a restricted road where children are not expected to walk. These special rules and the presence of a pedestrian child must be recognized by the lead autonomous vehicle or other autonomous vehicles at a sufficient distance out and the appropriate speed limits must be followed and in addition, the instructions for the appropriate speed limits must be passed on to the rest of the autonomous trucks in the convoy.

Blind Intersection: The invention checks that the speed limit in blind intersections is followed. The autonomous system must recognize that this is a blind intersection, and slow down for the intersection. California requires that the vehicle slows down within 100 ft from the intersection, and that the vehicle must drive at less than 15 mph. The speed that the vehicle must drive varies from locality to locality. The lead autonomous truck and other autonomous trucks need to slow down at a sufficient distance from the blind intersection and drive at a reduced speed depending on the locality. In addition, they must pass on instructions to the rest of the autonomous trucks in the convoy to do the same. A sufficient distance is one in which the lead autonomous vehicle or other autonomous vehicle is capable of slowing down from the intersection and drive at the reduced speed specified by the locality and also relay the instructions to the rest of the convoy to follow suit.

Alleys: Many localities have special rules for alleys or tight roadways. Some of the rules being verified by the invention include the maximum speeds in the alleys. The lead autonomous vehicle or other autonomous vehicle must be able to detect the maximum speed allowed in the alleys at a sufficient distance out. For example, California restricts the speed on alleys to 15mph. The speed limit on alleys could vary from one locality to another locality. The lead autonomous truck or autonomous trucks must detect that there is an alley present at a sufficient distance out and proceed at a much-reduced speed and also pass on instructions to the rest of the autonomous trucks to proceed at the same reduced speed specified by the locality.

Near Railroad Tracks: Many localities set specific speed limits near railroads. The invention checks if these rules are met. The vehicle usually must drive at a particular speed (<15 mph) within a zone (100 ft) if no signals are available. There is usually a requirement of a particular speed within a particular zone in many localities and the rule should be followed depending on the locality that the road network belongs to. These rules also require that the vehicle detect trains, and that the vehicles maintain certain separations from trains within a safety zone, unless those trains are stationary. Distances and times to be stationary change from locality to locality. The invention checks a variety of prerequisites, including detection distances, determination of zones, and speed limits. The lead autonomous vehicle and other autonomous vehicles must detect the presence of railroad tracks at a sufficient distance out and follow the appropriate rules depending on the particular locality of the road network and also instruct the other autonomous trucks to do the same. A sufficient distance out is one that gives enough time for the lead autonomous vehicle or other autonomous vehicle to detect the presence of railroad tracks and follow the rules of the locality as well as pass on the information to the rest of the autonomous vehicles in the convoy.

Light Rail Transit Vehicle Crossings: Like railroad tracks, many localities have different rules for light rail transit. The rules may differ from the rail rules. The invention has the capability of testing both rail and light rail. The lead autonomous vehicle and other autonomous vehicles must have the capability of distinguishing between rail and light rail at a sufficient distance out and follow the appropriate rules depending on which one is detected and also which locality that it is located. In addition, they should pass on instructions to the other autonomous trucks on the appropriate rules to follow depending on the type of rail that is detected originally. A sufficient distance out is one in which there is enough time for the lead autonomous vehicle or other autonomous vehicle to detect whether there is regular rail or light rail that is present and follow the appropriate rules as well as convey the instructions to follow these rules to the rest of the autonomous vehicles.

Near Streetcars, Trolleys, or Buses: As with rail and light rail, special rules apply for streetcars, trolleys, or buses. The invention checks if these special rules are met. The lead autonomous vehicle or other autonomous vehicles need to detect the presence of streetcars, trolleys, or buses a sufficient distance out and follow the appropriate rules based on the specific vehicle that is detected. In addition, they need to pass on instructions to the other autonomous vehicles in the convoy to follow the appropriate rules based on the particular vehicle that is detected. A sufficient distance out is one that gives enough time for the lead autonomous vehicle or other autonomous vehicle to follow the special rules in the presence of streetcars, trolleys, or buses and also transmit this information to the rest of the convoy to also follow the special rules.

Business or Residential Districts: Most localities have blanket speed limits for business or residential districts. The invention checks that these rules are met. The blanket speed limits may vary from one locality to another locality and the specific rule for that road network should be followed. The lead autonomous vehicle or autonomous vehicles must obey these blanket speed limits set by the specific locality at a sufficient distance out and pass on instructions to the other vehicles in the convoy of the speed limits that must be met. A sufficient distance out is one in which there is enough time to follow the blanket speed limit rules in the road network and also to transmit this information to the rest of the convoy of autonomous vehicles to also follow these same blanket speed rules.

Near Animals: Many municipalities have special rules when dealing with animals and livestock. The rules may involve the recognition of the animals or the road signs at distance and it usually requires the vehicle to lower its speed limit. The invention incorporates among its checks that animals are detected by the sensors and verifies that these rules are met. The lead autonomous truck or autonomous trucks must be able to detect the animals and livestock as well as the road signs posted at a sufficient distance out and slow down appropriately and pass on the information to the other autonomous trucks in the convoy. A sufficient distance out is one that gives enough time for the lead autonomous vehicle or other autonomous vehicle to follow the reduced speeds required by many municipalities as well as transmit the information to the rest of the autonomous vehicles in the convoy.

Many localities require that drivers perform a scan of the surrounding areas, both forwards and backwards, every few seconds. The lead autonomous vehicle or other autonomous vehicle should be able to conduct a scan of the surrounding areas using the sensors and also transmit the information to the rest of the autonomous vehicles to also correspondingly conduct a scan of the surrounding areas. The rules related to scanning usually involve tailgating. For example, many localities require that the distances maintained with other vehicles going in the same direction be at least 4 seconds. The distances maintained with other vehicles can vary from one locality to another locality. The lead autonomous vehicle and other autonomous vehicle should maintain an appropriate distance between the rest of the convoy based on the rules of the locality. If this is a rule of the locality, the invention will check that these rules are met. The autonomous lead vehicle or other autonomous vehicles must maintain a sufficient distance from the other autonomous vehicles and need to pass on the instructions to these autonomous vehicles that they need to keep a certain distance from the preceding autonomous vehicles and correspondingly pass on the information to the rest of the convoy to follow these rules.

Lane Control: As with signs, lane markings indicate to the driver that different rules apply. Understanding these lane markings needs to be performed with sufficient distance to react. A sufficient distance would involve having enough time for the lead autonomous vehicle or other autonomous vehicle to follow the rules for different lane markings. The invention will verify that the lane markings are detected with sufficient distance to react and that the specific rules that are embodied by those signs are followed. The lead autonomous vehicle and other autonomous vehicle will detect different lane markings with sufficient distance and also pass along instructions to the rest of the convoy of the amount of distance required for the detection of different lane markings. Again, a sufficient distance is one that involves having enough time for the lead autonomous vehicle or other autonomous vehicle to follow appropriate distance rules for a variety of lane markings and also to transmit this information to the rest of the convoy to follow suit.

Line Colors, which may come in different varieties depending on the locality: Usually, but not exclusively, these include Solid yellow lines, Broken yellow lines, Two solid yellow lines, Solid white lines, Broken white lines, Double white lines. Each of these line types represents a different set of rules governing the passing, or lack of it, rules. The invention verifies that the autonomous system recognizes each of the lines required by the locality, and given that the recognition was performed, that the rule embodied by the sign is followed. For example, the invention will note if the vehicle passes on a double solid yellow line. The lead autonomous vehicle and other autonomous vehicles should be able to detect the specific type of line markings at a sufficient distance out that are present and follow the subsequent rules that encompass that particular line marking. In addition, these autonomous vehicles need to pass on instructions to the rest of the autonomous vehicles in the convoy of the presence of these lines, their meanings, and appropriate action to take. A sufficient distance out is one that has enough time for the lead autonomous vehicle or other autonomous vehicle to follow the appropriate rules of the road for each type of lane color as well as pass on the information to the rest of the autonomous vehicles to follow suit.

Choosing a Lane: Most localities have rules referencing preferred passing and non-passing lanes. Usually, the lanes closer to the median are considered passing lanes and should not be occupied if room is available in the outer lanes. The invention will verify that these rules are met. The lead autonomous vehicle or other autonomous vehicles must recognize what are considered passing lanes and non-passing lanes at a sufficient distance out and follow the rules regarding this as well as pass on instructions to the rest of the convoy to also follow these rules. A sufficient distance out is one in which there is enough time for the lead autonomous vehicle or other autonomous vehicle to follow the rules regarding passing and non-passing lanes and also pass on the instructions to the rest of the convoy to follow suit.

Changing Lanes: Most localities include rules about lane changes. In general, they include rules forbidding lane changes in intersections and separation distances involving clearances with other vehicles and approaching speeds of other vehicles. The invention verifies that these rules are met, and the clearances are maintained. The lead autonomous vehicle and other autonomous vehicles should detect the road network and where lane changes are permitted and where they are not permitted at a sufficient distance out and should follow rules regarding lane changes and need to detect intersections at a sufficient distance out and make sure that no lane changes are conducted at intersections. In addition, these autonomous vehicles need to pass on instructions to the other autonomous vehicles in the convoy that lane changes cannot be done at intersections. A sufficient distance out is one in which there us enough time for autonomous vehicles to change lanes and give instructions to the other autonomous vehicles to change lanes.

Passing Lanes: Most localities include rules restricting traffic from passing in the right lane or leaving the paved roads to pass. Generally, passing on the right is only allowed if the left lane has a turning lane. Some localities allow for passing on the right lane only if the highway has three or more lanes in the same direction while other localities do not. The invention checks if the rules relative to passing lanes for the specific localities are followed. The lead autonomous vehicle must recognize if it can pass in the lane at a sufficient distance out and follow the rules of passing in the right lane used in the specific localities as well as transmit the same instructions to the rest of the convoy to also follow the instructions.

Carpool/HOV Lanes: Some localities have carpool/HOV lanes. These lanes may only be available at some times of the day, and only for a certain number of passengers onboard. Other rules only allow low emissions vehicle to use certain lanes. Depending on the rules, the vehicle will need to be aware of the time and time zone. The lead autonomous vehicle and other autonomous vehicles need to recognize the presence of carpool/HOV lanes at a sufficient distance out and follow the rules appropriately that are determined by the specific locality and also instruct the other autonomous trucks in the convoy to also do the same. A sufficient distance out is one that gives enough time for

Center Left Turn Lanes: Many roads and localities allow for center turn lanes. There are special rules that apply for these lanes. Most localities do not allow these lanes to become passing lanes, or for vehicles to drive more than a certain distance using that lane without turning. The invention verifies that these rules are met. The lead autonomous vehicle and other autonomous vehicles need to recognize the center left turn lanes when they are present at a sufficient distance out and follow the special rules associated with them. In addition, these autonomous vehicles need to instruct the rest of the convoy of the special rules associated with center left turn lanes. A sufficient distance out refers to having enough time to follow the special rules associated with the center turn lanes as well as instruct the rest of the convoy to follow these same special rules.

Turnout Areas and Lanes: Turnout areas are sometimes marked on two-lane roads to allow faster cars to pass. Several localities require that a slow vehicle being followed by a certain number of vehicles use the turnout lane to allow the faster vehicles behind to pass. This is complicated, as some localities require that the vehicle sense if five or more vehicles be queued behind to trigger. If the locality requires, the invention will check that the lead autonomous vehicle or autonomous vehicles use the turnout lanes under the required conditions. The lead autonomous vehicle and other autonomous vehicles should be able to recognize if there are turnout areas and lanes at a sufficient distance out and need to sense if there are five or more autonomous vehicles queued behind and follow the rules appropriately. In addition, they need to pass on the information and instructions to the rest of the convoy to recognize the turnout areas and lanes and to follow the rules appropriately. A sufficient distance out is one that gives enough time for the lead autonomous vehicle or other autonomous vehicle to follow the rules associated with turnout areas and lanes and also to instruct the rest of the autonomous convoy to follow these rules.

End of Lane Marking: Localities require that vehicles obey the end-of-lane markings. In this case, the invention will check if the lead autonomous vehicle or autonomous vehicles leave the lane with a sufficient distance and merge into traffic, following the appropriate separation distances. The lead autonomous vehicle and other autonomous vehicles need to recognize end-of-lane markings and leave the lane with a sufficient distance and merge into traffic following the appropriate separation distance. In addition, this information and instructions need to be passed on to the rest of the convoy. A sufficient distance refers to having enough time for the autonomous vehicles to leave the lane and merge into traffic as well as passing on this information to the rest of the convoy to also leave the lane and merge into traffic.

Yield Lines: Some localities have Yield Lines or “shark teeth.” These lines indicate to vehicles where they should stop or yield. These lines are commonly used in areas where ambulances, fire trucks, or other emergency response vehicles would enter the roadways. The vehicle must traverse the lines or stop before the lines, but not on the lines. The invention will check if the autonomous system can recognize the yield lines and that the appropriate rules are followed. The lead autonomous vehicle and other autonomous vehicles need to recognize the yield lines a sufficient distance out and follow the rules associated with these lines as well as instruct other autonomous trucks to follow the rules associated with the yield lines. A sufficient distance out refers to having enough time for the lead autonomous vehicle to follow the rules associated with the yield lines detected and also instruct the rest of the convoy to also follow these rules.

Shared Roadway, Bicycle Markings, and Bicycle Lanes: Most localities include special rules related to shared or non-shared bicycle lanes. The autonomous system must recognize if the bicycle lanes are present, and whether they are populated by bicycles or other allowed vehicles and follow the corresponding rules specified by the locality that the road network belongs to. The rules may include specialized speed limits and separation distances between the vehicles and the bicycles. There are differences if the vehicle encroaches into the bicycle's space, or if the bicycle encroaches into the vehicle's space; the behavior dictated by the locality changes accordingly. The lead autonomous vehicle and other autonomous vehicles must be able to recognize shared roadways, bicycle markings, and bicycle lanes at a sufficient distance out and follow the rules that are associated with these roadways and lanes and to instruct the rest of the convoy to follow the rules for these roadways and lanes. A sufficient distance out is one in which there is enough time for the lead autonomous vehicle or other autonomous vehicle to follow the rules specified by the locality for shared roadways, bicycle markings, and bicycle lanes as well as instruct the rest of the autonomous vehicles in the convoy to follow these rules.

Left and Right Turn: Most localities require that the user turns on the blinkers some distance ahead of the turn. The specific distance would vary from locality to locality and involve enough time to make the turn. The turns are allowed only in some intersections and sometimes at a certain time. The invention verifies that the blinkers are turned on at the appropriate distance and that the turns are only performed in areas and times allowed. The lead autonomous vehicle and other autonomous vehicles will detect at a sufficient distance out when there is a turn to be made at some intersections where it is allowed and turn on the blinkers at the appropriate distance. In addition, these autonomous vehicles should instruct the rest of the convoy that there is a turn to be made at an intersection and to turn on the blinkers at the appropriate distance. A sufficient distance out is one in which there is enough time for the blinkers to be turned on for a particular turn to be made and also to instruct the rest of the autonomous vehicles to follow the appropriate rules depending on the specific locality.

Public Transit Bus Lane: Many localities have rules related to Public Transit. These lanes may only be allowed to be used at certain times of the day. However, some localities allow vehicles to use the bus lane to make a turn. The invention will verify that the bus lanes are recognized and that the time is used to determine if the maneuver is legal. The lead autonomous vehicle will recognize the public transit bus lane at a sufficient distance out and note the time to determine if a turn on the bus lane is appropriate. It will also instruct the other autonomous vehicles coming behind in the convoy on what to do regarding making a turn on the bus lane depending on the time of the day. A sufficient distance out is one in which there is enough time to make the turn on the bus lane if it is appropriate depending on the locality that the road network exists in.

Right Turn Against a Red Traffic Signal: Many localities allow for right turns on a red traffic light, while some others do not. The invention will verify that these rules are followed. Just as importantly, vehicles are usually allowed to encroach on the bike lanes for a certain amount of distance before making a right turn. Most localities require that there is a full stop before making a right turn. The invention verifies that these rules are met. The lead autonomous vehicle and other autonomous vehicles will sense at a sufficient distance out that there is a red traffic light present and determine if a right turn is allowed and also if it is allowed to encroach a bike lane while making a right turn and follow the rules appropriately. In addition, they must instruct the others in the convoy to also follow the rules appropriately. A sufficient distance out is one in which there is enough time to follow the appropriate rules when there is a right turn against a red traffic signal.

Right Turn onto a Road with a Dedicated Lane: Some localities have dedicated right turns that do not require the vehicles to stop. The invention verifies that the autonomous system stops in the right turn lane where it is required and does not stop in right turn lanes where it is not required. The lead autonomous vehicle and other autonomous vehicles should be able to recognize at a sufficient distance out when there is a right turn that does not require the vehicle to stop and when there is one that requires a vehicle to stop. In addition, the autonomous trucks should instruct the rest of the convoy of the appropriate action to take depending on whether the right turn requires a stop or not. A sufficient distance out is when there is enough time for the right turn lane to be detected and follow the appropriate rules for the specific localities of the road network being travelled.

Left Turn from a Two-Way Street: Depending on the signals, most localities only allow that the left lane turns left to the furthest left lane, unless marked otherwise. The invention checks if these rules are met and that the signals are recognized. The lead autonomous vehicle and other autonomous vehicles should be able to recognize at a sufficient distance out that in most places that left lanes turns left only to the furthest lane, unless marked otherwise. They should also instruct the other autonomous trucks in the convoy that the left lanes turn left only to the furthest lanes in most localities and to follow this rule. A sufficient distance out refers to having enough time to follow the rules of specific localities regarding a left turn from a two-way street.

Left Turn from a One-Way Street onto a Two-Way Street: Most localities require certain separations between the turning vehicle and the incoming traffic. Other localities describe separation in time and not distance, to deal with slow traffic in the road being merged. The invention verifies that these rules are being followed. The lead autonomous vehicle and other autonomous vehicles should recognize that there is a left turn being conducted from a one-way street onto a two-way street at a sufficient distance out and should follow the appropriate rules for this type of turn as well as instruct the rest of the autonomous trucks in the convoy to follow these rules. A sufficient distance out is one where there is enough time for the appropriate rules to be followed for a left turn from a one-way street onto a two-way street.

Left Turn from a One-Way Street onto a One-Way Street: Most localities require a full stop, though others do not. The invention verifies that these rules are met. The lead autonomous vehicle and the other autonomous vehicles should recognize that there is a left turn conducted from a one-way street onto a one-way street at a sufficient distance out and that this requires a full stop in some cases while it does not require one in other cases. They need to recognize which case applies to the situation and also instruct the rest of the convoy to follow the appropriate action. A sufficient distance out is one in which there is enough time for a lead autonomous vehicle to follow the appropriate rules for a left turn from a one-way street onto a one-way street and also pass on the information and instructions to the rest of the convoy to also follow the same rules specified by the locality of the road network.

Right Turn from a One-Way Street onto a One-Way Street: Most localities require a stop in addition to the distance and time requirements. The invention verifies that these rules are met. The lead autonomous vehicle and other autonomous vehicles should be able to recognize that there is a right turn being conducted from a one-way street onto a one-way street at a sufficient distance out and accordingly stop with the correct distance and timing requirements. This stop is required in most localities so it must recognize when it is required and when it is not required and instruct the rest of the autonomous trucks in the convoy to stop at the correct distance and times if needed. A sufficient distance out would be one that gives enough time to follow the appropriate rules given by many localities for a right turn from a one-way street onto a one-way street.

Turn at a “T” Intersection from a one-way street into a two-way street. The lead autonomous vehicle and other autonomous vehicles must recognize that there is a turn at a “T” intersection from a one-way street into a two-way street at a sufficient distance out and follow the appropriate rules for these types of turns and instruct the rest of the convoy to follow the appropriate rules. A sufficient distance out is one that gives enough time for the lead autonomous vehicle or other autonomous vehicle to follow the rules associated with a turn at a “T” intersection.

Legal U-Turns: Most localities require large separations before allowing a U-turn. Others set timing-based separations. There are also a significant number of rules disallowing U-turns under a variety of conditions: railroad tracks, divided highways, hills, rain, fog, or signs disallowing it. The invention verifies that the vehicle follows these rules. The lead autonomous vehicle and other autonomous vehicles must recognize whether a U-turn is permitted or not in the particular road conditions at a sufficient distance out. In addition, it must be able to detect a large separation before allowing a U-turn or detect a timing-based separation of the U-turn at a sufficient distance out. The lead autonomous vehicle or other autonomous vehicle must also instruct the rest of the autonomous vehicles in the convoy of whether a U-turn is allowed and also of the distance and timing-based separations in U-turns that are allowed. A sufficient distance out is one in which there is enough time for the lead autonomous vehicle or other autonomous vehicle to make a legal U-turn and also give instructions to the rest of the convoy to make legal U-turns.

Parking on a Hill: Many localities require that vehicles parked on a hill point their wheels so that the vehicle would go towards the curb if the brakes were to fail. Some localities also require that the vehicle point towards the curb when parked in a flat area. These rules usually only apply in areas with curbs, and not in a parking lot. The invention verifies that these rules are met. The lead autonomous vehicle or the other autonomous vehicles should recognize the rules that exist for parking on the hill at a sufficient distance out in many cases such as pointing their wheels so that it does towards the curb if the brakes were to fail both in a hill and in a flat area. They should be able to detect in which case these rules need to be followed and instruct the rest of the convoy to do the same. A sufficient distance out is one in which the lead autonomous vehicle or other autonomous vehicle follows the rules related to parking in a hill and also transmits this information to the rest of the convoy to do the same.

Parallel Parking: Most localities have strict rules on parallel parking, specifying distances to the curb and between vehicles. The invention will verify that these rules are met. The lead autonomous vehicle and the other autonomous vehicles should be able to recognize parallel parking and the distances to the curb and between autonomous vehicles at a sufficient distance out as well as instruct other autonomous vehicles in the rest of the convoy to also follow the distance rules in parallel parking. A sufficient distance out is one in which the lead autonomous vehicle or other autonomous vehicle recognizes the rules of parallel parking and also transmits the information on these rules to the rest of the autonomous convoy.

Parking at Colored Curbs: Curbs are painted in different localities to represent different regulations: White, Green, Yellow, Red, Blue, etc. The localities use these colors to stipulate the amount of time and use of the particular curb related to parking. For example, a red curb usually means that no stopping, standing, or parking is allowed. Other areas may be more permissive. Some areas change the rules depending on the time of the day, or even if the vehicle has specialized placards. The invention verifies that these rules are met. The lead autonomous truck and other autonomous trucks need to recognize when it is permissible to park at different colored curbs at a sufficient distance out and at different times of the day. Also, these autonomous trucks need to instruct the rest of the convoy of the different rules that exist for different colored curbs and at different times of the day. A sufficient distance out is one in which there is enough time for the lead autonomous vehicle or other autonomous vehicle to follow the rules that exist for different colored curbs as well as transmit these instructions to the rest of the convoy.

Illegal Parking: Most localities have very strict rules of specifying locations where vehicles cannot be parked. These usually include signed areas, crosswalks, sidewalks, disabled parking areas, zero-emission vehicles, tunnels, bridges, railroads, wrong side of the street, freeways, etc. These rules vary widely between different localities. The invention checks that those rules are met by the lead autonomous trucks or other autonomous trucks. The lead autonomous truck and autonomous trucks need to be able to detect illegal parking at a sufficient distance out and follow the strict rules where vehicles cannot be parked. In addition, the autonomous trucks need to instruct the rest of the convoy about the strict rules in which vehicles cannot be parked. A sufficient distance out is one in which there is enough time for the lead autonomous vehicle or other autonomous vehicle to follow the rules related to illegal parking and also transmit the information to the rest of the autonomous vehicles in the convoy coming behind.

Turning signals: Most localities have specific rules on when these signals must be applied. Some localities require that vehicles use the turning or hazards signals while stopping or slowing down. Most localities require that the turning signals be used when attempting to park, or when changing lanes. The rules change depending on if the areas are streets or highways. For example, on the highway, there may be a requirement that the signals are turned on five seconds before changing lanes; in a city street, the rules may stipulate a distance. The invention verifies that the local rules are met. The lead autonomous vehicle and autonomous vehicles should be able to detect turning signals at a sufficient distance out and follow the specific rules on when these signals must be applied such as when one needs to park or when changing lanes and are different for different types of roads. These autonomous vehicles should also be able to instruct the other autonomous trucks of the presence of turning signals and follow the applicable rules associated with them. A sufficient distance out refers to one in which there is enough time for the lead autonomous vehicle or other autonomous vehicle follow the rules associated with turning signals in different types of situations as well as transmit these instructions to the rest of the autonomous vehicles.

Following Distances: Most localities specify a following distance requirement. These requirements change depending on a variety of conditions: road type, weather, vehicle type, etc. The invention verifies that the local rules are met. The lead autonomous vehicle and other autonomous vehicles should be able to recognize the following distance requirements that are specified by most localities at a sufficient distance out which also can change due to a variety of different conditions. They must be able to detect when these distance requirements are required and how they vary for different conditions. In addition, they must pass on the information and instructions to the other autonomous vehicles about the following distance requirements at different conditions. A sufficient distance out is one in which there is enough time for the rules related to following distances are met and these rules are passed on to the rest of the autonomous vehicles.

Space to Merge: Most localities specify a required space to merge so as not to encroach on other vehicles. This space is often provided as distance or time. The invention verifies that the local rules are met. The lead autonomous vehicle and other autonomous vehicles should be able to recognize the required space to merge specified by the locality at a sufficient distance out so as not to encroach on other vehicles and also should pass on instructions to the rest of the autonomous trucks of the space to merge so as not to encroach on other vehicles and to follow these rules. A sufficient distance out is one in which there is enough time for the lead autonomous vehicle or other autonomous vehicle to follow the specific rules related to the required space to merge as well as pass on the information to the rest of the autonomous vehicles.

Space to Cross or Enter: Most localities specify a required space to cross or enter so as not to encroach on other vehicles. This space is often provided as distance or time. The invention verifies that the local rules on the required space to cross or enter are met. The lead autonomous vehicle or other autonomous vehicles must be able to recognize the required space to cross or enter at a sufficient distance out so as not to encroach on other vehicles that is required by most localities. They must be able to detect when this requirement is needed and when it is not necessary. In addition, they must pass on instructions to the rest of the convoy to follow the rules when applicable. A sufficient distance out is one in which there is enough time for the lead autonomous vehicle to follow the appropriate rules on the space to cross or enter as well as pass on the information to the rest of the autonomous convoy.

Space to Exit: Most localities specify a required space to exit so as not to encroach on other vehicles. This space is often provided as distance or time and needs to be at a sufficient distance out. The invention verifies that the local rules are met for the required space to exit. The lead autonomous vehicle or autonomous vehicles must be able to detect that there is a required space to exit so as not to encroach on other vehicles in most localities. These autonomous vehicles need to be able to recognize when there is a space needed to exit and when it is not necessary and also pass on these instructions to the rest of the convoy to follow. A sufficient distance out is one in which there is enough time for the rules related to the space to exit are met and also for these instructions to be transmitted to the rest of the autonomous vehicles.

Lights: Most localities require that the vehicles turn on their light from dusk to dawn and when it is cloudy, raining, or foggy. Some other localities require that the lights are on all the time. Emergency lights must be turned on if the vehicle is having problems and cannot meet the traffic speed. The invention verifies that the local rules are met on the proper use of regular lights and emergency lights that are detected at a sufficient distance out. The lead autonomous truck and other autonomous truck should be able to recognize when it is dusk and dawn and when it is cloudy, raining, or foggy and appropriately turn on the lights. They should also pass on these instructions to the rest of the convoy on the rules when lights should be turned on. A sufficient distance out is one in which there is enough time for the lead autonomous vehicle or other autonomous vehicle to follow the rules about turning on lights in different road conditions as well as pass on the information to the rest of the convoy coming behind to follow these rules about regular and emergency lights.

Wipers: Most localities require that the wiper be turned on in the case of rain. The invention verifies that the local rules are met for turning on wipers when there is rain. The lead autonomous vehicle and other autonomous vehicles should be able to recognize when it is raining and to turn on the wipers. They should also be able to recognize when it is not raining and keep the wipers off. In addition, they should pass on instructions to the rest of the autonomous vehicles in the convoy that the wipers should be turned on if it is raining.

Horn: The rules controlling the use of the horn vary widely with the locality. Most areas require that the horn be used in the case of an impending collision, or in narrow mountain roads that do not allow to see more than a certain distance. The invention verifies that the local rules are met. The lead autonomous vehicle and autonomous vehicles will follow the rules regarding the use of horns such as in the case of an impending collision or in a narrow mountain road that does not allow one to see more than a certain distance. In addition, these rules regarding horns need to be passed on to the rest of the convoy to follow the rules related to the use of horns for different uses.

Emergency Vehicles: Most municipalities have special rules for Emergency vehicles. Some of the rules involve separation distances. For example, California requires a 300 ft separation behind a fire engine, police vehicle, ambulance, or other emergency vehicle that has flashing sirens. There should be a sufficient separation distance behind a fire engine, police vehicle, ambulance, or other emergency vehicle which would vary from one municipality to the next. These rules require that the lead autonomous vehicle or other autonomous vehicle detects the flashing sirens a sufficient distance out, and the fact that they are coming from an emergency vehicle. The invention verifies that the local rules are met. The lead autonomous vehicle and other autonomous vehicles should be able to recognize the flashing sirens and the separation distances for emergency vehicles such as fire engines, police vehicles, ambulance, and other services. These autonomous vehicles should also be able to detect when these special rules are applicable and, in the municipalities, where it is specified. In addition, these autonomous vehicles should be able to pass on instructions to the rest of the autonomous trucks on the separation distances required. A sufficient distance out is one in which the lead autonomous vehicle or other autonomous vehicle can follow the special rules regarding a variety of different emergency vehicles and also transmit the instructions to the rest of the autonomous convoy.

Motorcycles: Most localities include special rules for motorcycles, including separation distances. This requires that the vehicles recognize that the object is a motorcycle, as opposed to other traffic, and that the separation distances are maintained at a sufficient distance out. The invention verifies that the local rules on separation distances detected at a sufficient distance out are met. The lead autonomous vehicle and other autonomous vehicles need to be able to detect the presence of motorcycles as opposed to other types of vehicles and maintain the proper separation distances in the localities that require specific separation distances. They also need to be able to detect the cases where there is not a need for a specific separation distance between the motorcycles and autonomous trucks. These autonomous vehicles also should pass on instructions to the rest of the convoy of the proper separation distances between motorcycles and autonomous trucks in localities that require them. A sufficient distance out is defined as one in which there is enough time for maintain proper separation distances between motorcycles which are required in many localities and also to pass on these rules to the rest of the autonomous vehicles coming behind.

Bicycles: As with motorcycles, most localities include rules that are specific to bicycles and require the traffic to distinguish bicycles from other modes of transportation. The “following” and “separation” distances are usually different between bicycles and motorcycles. In order to follow these rules, the lead autonomous vehicle and other autonomous vehicles usually must be able to categorize the differences between the two at a sufficient distance out or follow more restrictive rules. The invention verifies that the local rules are met. The lead autonomous vehicle and other autonomous vehicles must recognize the presence of bicycles compared to other types of transportations and that the following and separation distances are different for bicycles compared to motorcycles in most localities and follow the separation distance rules. Also, the autonomous vehicles must give instructions to the rest of the convoy of the specific separation distances required between autonomous vehicles and bicycles as applicable in the specific locality. A sufficient distance out is one in which there is enough time to follow the rules specifically for bicycles as opposed to motorcycles and to pass on these rules to the rest of the convoy coming behind.

Blind pedestrians: Some localities have different rules for pedestrians that are blind. These rules usually provide right-of-way to these special pedestrians no matter where they are. This creates yet a new category for which the rules are different. The invention verifies that the local rules are met. The lead autonomous vehicle or autonomous vehicles must recognize that there is a blind pedestrian walking with a stick anywhere around the surroundings at a sufficient distance out and give right-of-way for them in the localities that require this to be done. In addition, the autonomous vehicles need to recognize in which localities this requirement needs to be met and which localities there is no such requirement. They also need to give instructions to the rest of the convoy that there is a blind pedestrian walking with a stick and give right-of-way in the localities where it needs to be done. A sufficient distance out is one in which the blind pedestrian is detected and given right-of-way in specific localities that require them as well as passing on these rules to the rest of the convoy to follow the special rules related to the blind pedestrians.

Road Workers and Work Zones: Most localities have special signs used for directing traffic during road repair. The signs may include stop, slow, go, and different speed limits. Sometimes these signs are posted, and sometimes they are carried by road workers. If the locality requires that autonomous vehicles must detect these signs, the invention will verify that the rules are being met. The lead autonomous vehicle must be able to detect road workers and work zones as well as special signs posted or carried by road workers for directing traffic during road repair that exist in most localities at a sufficient distance out. In addition, these autonomous vehicles need to pass on instructions to the rest of the convoy about the presence of road workers and work zones as well as special signs that are posted or carried by road workers to follow the rules that apply in many localities. A sufficient distance out is one in which there is enough time for the autonomous vehicle to follow the signs posted on the street or carried by road workers during traffic and work zones as well as instruct the rest of the convoy to follow these rules.

Driving During Hazards: Most localities change the speed rules depending on weather conditions. For example, some localities specify that if the road is wet, traffic should drive 10 mph under the speed limit, and 5 mph for ice. The specific speed limits would vary with locality to locality. If the lead autonomous vehicle or autonomous vehicles drive in areas where these rules are enforced, the autonomous vehicle must be able to recognize these conditions and follow the rules. The invention verifies that the local rules are met. The lead autonomous vehicle and autonomous vehicles should be able to recognize the change in speed rules that exist in most localities depending on weather conditions such as in rain or ice and must do so at a sufficient distance out. Also, the autonomous vehicles must recognize if the locality that the road is in enforces these speed rules. In addition, the autonomous trucks must also give instructions to the rest of the convoy of these speed rules to follow depending on weather conditions such as rain and ice. A sufficient distance out is one in which there is enough time for the lead autonomous vehicle or other autonomous vehicle to detect the speed changes that are required for specific types of hazardous conditions and also to transmit this information to the rest of the convoy that is coming behind.

Special Locale Rules: Some locales have specific rules to protect flora or fauna of the locale. For example, Australia has specific rules related to driving next to Koala bears. These rules may require the vehicle to detect and classify some animals or conditions that are not required in other locales. The invention verifies that the local rules are met. The lead autonomous vehicle or other autonomous vehicle should be able to detect the presence of the flora or fauna at a sufficient distance out and also transmit the information to the rest of the autonomous convoy. A sufficient distance out is one in which there is enough time for the specific rules related to flora and fauna are met and these rules are transmitted to the rest of the autonomous convoy to follow suit.)

1. A system in which a lead autonomous vehicle or another autonomous vehicle generates road information and transmits the information to the rest of the convoy comprising a set of sensors that can see features in a road network.)

2. The system of claim 1 wherein the sensor comprises a camera, a LADAR, a ranging sensor, or an acoustic sensor.)

3. The system of claim 1 wherein the a priori knowledge from the lead autonomous vehicle or other autonomous vehicles can automatically generate RNDF for the autonomous vehicles that follow these autonomous vehicles.)

4. The system of claim 1 where there is a communication mechanism between the database of the lead autonomous vehicle or other autonomous vehicles and the database of the rest of autonomous vehicles in the convoy.)

5. The system of claim 1 where is a localization system on both the lead autonomous vehicle or other autonomous vehicles and the rest of the autonomous vehicles that come behind.)

6. The system of claim 1 wherein the lead autonomous vehicle or other autonomous vehicles updates the information sent to the rest of the convoy of autonomous vehicles.)

7. The system of claim 1 wherein the lead autonomous vehicle or other autonomous vehicles sees a square red and white regulatory sign such as a Do Not Enter sign at a sufficient distance out before the rest of the autonomous trucks and passes the information to the rest of the convoy so they can be prepared to follow the instructions on the sign.)

8. The system of claim 1 wherein the lead autonomous vehicle or other autonomous vehicles sees a sign with a red circle with a red line through it such as a no U-turn sign or a no right turn or a no left turn at a sufficient distance out before the rest of the autonomous trucks and passes the information to the rest of the convoy so that they can be prepared to not do the action indicated by the sign.)

9. The system of claim 1 wherein the lead autonomous vehicle or other autonomous vehicles sees a black and yellow circular sign or an x-shaped sign is at a sufficient distance out before the rest of the autonomous trucks and passes the information to the rest of the convo so they can be prepared to look, listen, slow down, and stop if necessary and let any trains pass before proceeding.)

10. The system of claim 1 wherein the lead autonomous vehicle or other autonomous vehicles sees a blue and white sign when stalled in the railroad tracks at a sufficient distance out before the rest of the autonomous trucks and passes the information to the rest of the convoy so that they can be prepared to follow the instructions on the sign.)

11. The system of claim 1 wherein the lead autonomous vehicle or other autonomous vehicles sees a five-sided sign at a sufficient distance out before the rest of the autonomous trucks and passes the information to the rest of the convoy so that they can be prepared to stop if there are children in the crosswalk.)

12. The system of claim 1 wherein the lead autonomous vehicle or other autonomous vehicles sees a four-sided diamond-shaped sign or white regulatory sign before the rest of the autonomous trucks and passes the information to the rest of the convoy so that they can be aware of the specific road condition and respond appropriately.)

13. The system of claim 1 wherein the four-sided diamond-shaped sign is a thru traffic merge left or a road closed ahead or a road machinery ahead or a shoulder work ahead or flammable, or a radioactive, or an explosives, or a toxic or a slippery when wet or a merging traffic, or a divided highway, or a sharp turn, or a two way lane, or a crossroad, or a stop ahead, or a yield ahead or a directional arrow, or a curve, or an intersection, or a winding road sign.)

14. The system of claim 1 wherein the white regulatory sign is a pedestrian or a bicyclist or a motor-driven traffic prohibited or a two way traffic ahead or a no parking any time or a yield to uphill traffic or a one way or an emergency parking only or a no turns or a left turn yield on green or a do not pass or an only or a turn with two different arrows or a do not block intersection or a speed limit sign or a slower traffic keep right or a keep right or a do not stop on tracks or a 3 tracks sign.)

15. The system of claim 1 wherein the lead autonomous vehicle or other autonomous vehicles generate information on traffic circles or embankments or convoy pullovers or lane changes or muddy or icy conditions or a stop sign or yield sign or solid red traffic light or red arrow light or flashing red traffic light or solid yellow traffic light or yellow arrow light or flashing yellow light or solid green traffic light or green arrow light or a traffic signal not working or two solid yellow lane markings or broken yellow lines or solid white lines or broken white lines or crosswalks or intersections or roundabouts or mountain roads or maximum or minimum speed limits or reduced speeds or during heavy traffic or bad weather or when towing vehicles or buses or large trucks or around children or blind intersections or alleys or roads near railroad tracks or light rail transit vehicle crossings or roads near streetcars, trolleys, or buses or lights or wipers or horn or emergency vehicles or bicycles or motorcycles or blind pedestrians or road workers or work zones or driving during hazards or special locale rules business or residential districts or animals near roads, or lane control, or line colors or choosing a lane or passing lanes or carpool/HOV lanes or center left turn lanes, or turnout areas or lanes or end of lane marking or yield lines or shared roadway or bicycle markings, or bicycle lanes or left turn or right turn or public transit bus lane or right turn against a red traffic signal or a right turn onto a road with a dedicated lane or a left turn from a two-way street or a left turn from a one-way street onto a two-way street or a left turn from a one-way street onto a one-way street or a right turn from a one-way street onto a one-way street or a turn at a “T” intersection from a one-way street into a two-way street or a legal U-turn or parking on a hill or parallel parking or parking at colored curbs or illegal parking or turning signals or following distances or space to merge or space to cross or enter or space to exit at a sufficient distance out for the rest of the autonomous vehicles so they can follow the appropriate rules.
